(19) United States
(12) Patent Application Publication
(10) Pub. No.: US 2017/0171296 A1
(43) Pub. Date: Jun. 15, 2017

(54) METHOD AND ELECTRONIC DEVICE FOR DOWNLOADING DATA

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Guannan YAN, Beijing (CN)

(21) Appl. No.: 15/240,374

(22) Filed: Aug. 18, 2016

Related U.S. Application Data
(63) Continuation of application No. PCT/CN2016/088674, filed on Jul. 5, 2016.

(30) Foreign Application Priority Data
Dec. 15, 2015 (CN) 201510931609.5

(51) Int. Cl. H04L 29/08; G06F 17/30

(52) U.S. Cl. CPC H04L 67/06; H04L 67/322; G06F 17/30091; G06F 17/30233

(57) ABSTRACT

Methods and electronic devices for downloading data are disclosed. In one illustrative implementation, a method may include detecting whether a first data downloading instruction for a first data file to be downloaded is received; reserving a first storage space for the first data file when the first data downloading instruction is received; and downloading the first data file to the first storage space. In some embodiments of the present disclosure, data information corresponding to a downloaded data file is stored in a reserved storage space, such that the data file with downloaded data information covers the storage space, thereby effectively preventing occurrence of the phenomenon where download of a data file fails to be continued due to insufficient storage space in a terminal during downloading of the data file and thus a loss of data is rendered, and as such effectively improving an efficiency of data downloading.

### CROSS REFERENCE TO RELATED APPLICATION

This application is a continuation of International PCT patent application No. PCT/CN2016/088674, filed on Jul. 5, 2016 (attached hereto as an Appendix), and claims a benefit/priority of Chinese patent application No. 201510931609.5, entitled “Method, Device and Terminal for Downloading Data,” filed with the State Intellectual Property Office of China on Dec. 15, 2015, all of which are incorporated herein by reference in entirety.

### BACKGROUND

Field

The present disclosure belongs to a data downloading technical field, more particularly, relates to a method and an electronic device for downloading data.

Description of the Related Art

To ensure the fluency of watching video or listening to music in the case where the video or music has a relatively large data file, a user may generally download the data file to his terminal, and then watches the downloaded local file, thereby improving his visual or audio experience.

In the related art, during downloading data, a user generally downloads one or more data files simultaneously. A downloading speed of the data files may vary due to download resources or network speed, so that a plurality of data files to be downloaded simultaneously by a user may be completed at different times. In the case where a user wants a data file among data files being simultaneously downloaded to be watched or completed download firstly, a storage space of a terminal is likely to be occupied by other downloaded data files of which the downloading speed is more quickly because of their abundant download resources, so that once the remained storage space of the terminal is insufficient, the downloading of the required data file will be interrupted.

At present, it is more likely that a data packet of a data file is lost due to a long time of interrupted downloading of the data file or other reasons. Although download of the data file may be continued by pausing downloading of other files or deleting other useless data to vacate a storage space for the data file, the above problems are likely to be occurred again, such that the data file, even if the download is completed, cannot be available to watch.

### OVERVIEW OF SOME ASPECTS

To overcome such problem(s) existing in the related art, the present disclosure provides a method and an electronic device for downloading data.

According to a first aspect of embodiments of the present disclosure, there provides a method for downloading data, including: detecting whether a first data downloading instruction for a first data file to be downloaded is received; reserving a first storage space for the first data file when the first data downloading instruction is received; and downloading the first data file to the first storage space.

According to a second aspect of embodiments of the present disclosure, there provides a non-volatile computer storage medium which is stored with computer executable instructions, and the computer executable instructions are set to execute any one of the above methods for downloading data.

According to a third aspect of embodiments of the present disclosure, there provides a electronic device including one or more processors and a memory, the memory is stored with instructions executable by the one or more processors, and the instructions are set to execute any one of the above methods for downloading data.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

To illustrate embodiments of the present disclosure or technical schemes in the prior art more clearly, figures used in the description of embodiments or the prior art are described briefly as follows. It is obvious that the figures in the description below are some embodiments of the present disclosure, and one of ordinary skilled in the art can obtain other figures according to those following figures without any creative work.

FIG. 1 is a schematic flowchart of a method for downloading data according to an embodiment;

FIG. 2 is a schematic flowchart of step S101 in a method for downloading data according to an embodiment;

FIG. 3 is a schematic flowchart of a method for downloading data based on step S101 according to an embodiment;

FIG. 4 is a schematic flowchart of obtaining priority levels of a plurality of data downloading instructions according to another embodiment;

FIG. 5 is a schematic flowchart of step S102 in a method for downloading data according to an embodiment;

FIG. 6 is a schematic flowchart of step S103 in a method for downloading data according to an embodiment;

FIG. 7 is a schematic structure diagram of a device for downloading data according to an embodiment;

FIG. 8 is a schematic detailed structure diagram of a downloading unit of another device for downloading data according to an embodiment;

FIG. 9 is a schematic detailed structure diagram of a detecting unit according to an embodiment;

FIG. 10 is a schematic structure diagram of a further device for downloading data according to an embodiment;

FIG. 11 is a schematic structure diagram of another device for downloading data according to an embodiment;

FIG. 12 is a schematic detailed structure diagram of a space reserving unit according to an embodiment; and

FIG. 13 is a schematic structure diagram of an electronic device for performing a method for downloading data according to an embodiment.

### DETAILED DESCRIPTION OF ILLUSTRATIVE IMPLEMENTATIONS

Embodiments are described in detail herein, examples of which are illustrated in figures. In the following descriptions, unless indicated otherwise, same reference numerals in different figures indicate same or similar elements. The implementations described in the following embodiments do not represent all implementations according to the present disclosure. On the contrary, they are merely examples of devices and methods according to some aspects of the present disclosure, as defined in the attached claims.

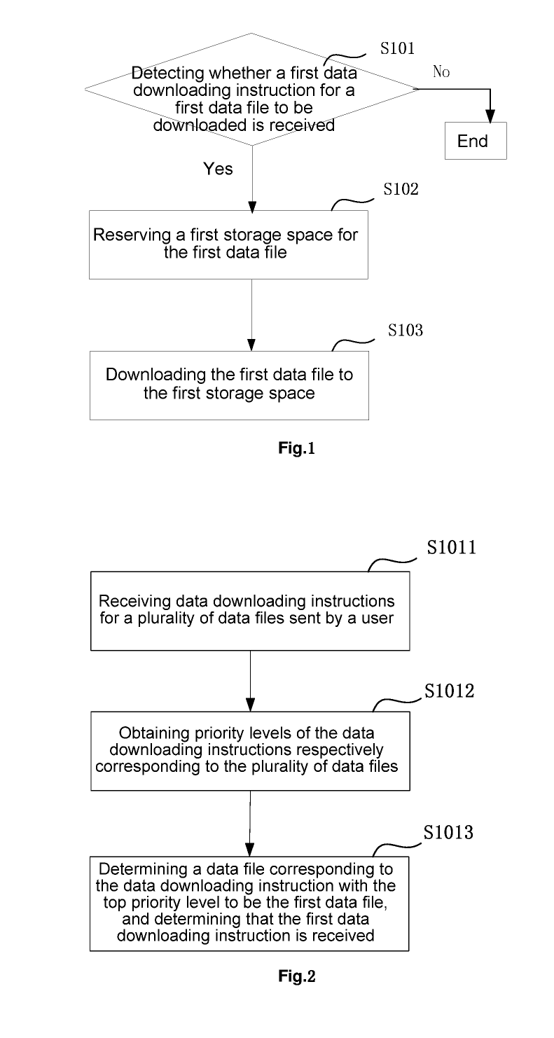

FIG. 1 is a flowchart illustrating a method for downloading data according to an embodiment, and the method is applied to a terminal such as a mobile terminal and includes the following steps.

At step S101, whether a first data downloading instruction for a first data file to be downloaded is received is detected. If not, the procedure is ended, and data files can be downloaded according to the related art.

In an embodiment of the present disclosure, when data is downloaded in a terminal, for example, when a user download a plurality of data files by clicking, one or more data files will be downloaded simultaneously. However, to ensure that a desired data file can be viewed, the desired data file should be completed download. The desired data file is the first data file to be downloaded in the present embodiment. The first data downloading instruction is a downloading instruction for downloading the first data file and storing the same to a storage space of a terminal. Whether the first data downloading instruction is received is determined by detecting an identity identification flag of the first data downloading instruction, and the identity identification flag may be a character string, and may be an identity identification flag indicating that a server can respond to downloaded data files.

Furthermore, the first data downloading instruction may also be a data downloading instruction corresponding to a data file not designated by the user, and is determined by sequence that each data file is started being downloaded from the clicking by the user to start downloading, such that the data file having the earliest downloading starting time is the first data file.

When the first data downloading instruction for the first data file to be downloaded is received, at step S102, a first storage space is reserved for the first data file.

The first storage space is a storage space in a terminal for storing the first data file. To ensure that data information of the downloaded first data file can be completely stored in the first storage space, a size of the first storage space is at least the same as, or slightly greater than that of data in the first data file, thereby facilitating the storing of the data information corresponding to the downloaded first data file in the first storage space, after the first storage space is reserved in the remained storage space in a terminal.

Furthermore, in an embodiment of the present disclosure, the size of the first storage space may be smaller than, certainly may also be greater than that of the remained storage space of a memory device in a terminal. If the size of the first storage space is greater than that of the remained storage space of a memory device in a terminal, some useless information in the terminal is required to be cleared by the user, so as to ensure the first storage space to be reserved, thereby facilitating the storing of the data information corresponding to the first data file.

At step S103, the first data file is downloaded to the first storage space.

The first storage space is used for storing the data information of the first data file, and thus the data information of the first data file may be stored in the first storage space either during the downloading when the first data file is downloaded or after the downloading is completed.

By application of the method, the first storage space can be reserved in the remained storage space of a terminal in advance when the first data file is downloaded, such that part of the remained storage space in the terminal is occupied, and the data information corresponding to the first data file can be stored in the first storage space after it is completed download, which ensures the downloading of the first data file to be completed, ensures a good watching effect for a user, and effectively improves reliability in data downloading and user experience.

FIG. 2 is a flowchart illustrating another method for downloading data according to an embodiment, and the method for downloading data includes the following steps.

At step S1011, data downloading instructions for a plurality of data files sent by a user are received.

In an embodiment of the present disclosure, a plurality of data downloading instructions for a plurality of data files may be received simultaneously, and a data downloading instruction for one data file may also be received. When the data downloading instruction for the one data file is received, it can be executed according to step S102.

When the data downloading instructions for the plurality of data files are received, at step S1012, priority levels of the data downloading instructions respectively corresponding to the plurality of data files are obtained.

The priority level of data downloading instruction indicates a sequence in which a data file corresponding to the data downloading instruction is to be downloaded and stored in a terminal. In an embodiment of the present disclosure, the data downloading instruction may carry a priority level identification flag that may be a character string, through which the priority level of the data downloading instruction is determined, and then the priority level of downloading data file corresponding to the data downloading instruction is determined. For example, when the priority level identification flag is a time flag indicating when a data file is started being downloaded, if priority level identification flags of two data downloading instructions are a first time flag and a second time flag respectively, and the time represented by the first time flag is earlier than that represented by the second time flag, it means that the priority level of the data downloading instruction corresponding to the first time flag is higher than that of the data downloading instruction corresponding to the second time flag.

When the priority levels of the data downloading instructions are obtained, at step S1013, a data file corresponding to the data downloading instruction with the top priority level is determined to be the first data file, and the first data downloading instruction is determined to be received.

In the embodiment of the present disclosure, the priority levels of the data downloading instructions corresponding to the plurality of data files respectively are obtained in step S1012, and thus the priority levels of downloading the data files can be obtained, and the data file corresponding to the data downloading instruction with the top priority level is determined to be the first data file to be downloaded by a user in the embodiment of the present disclosure according to the priority levels, so that the data downloading instruction corresponding to the first data file is determined to be received, and the data downloading instruction is the first data downloading instruction in step S101.

Furthermore, the first data file and the first data downloading instruction in embodiments of the present disclosure do not indicate the ranks of their priority levels, instead, they are mainly used for distinguishing the data file to be prior downloaded by a user from other data files when a plurality of data files exist simultaneously.

By application of the method, priority levels of downloading data files can be determined from data downloading instructions corresponding to a plurality of data files, such that a data file to be downloaded is determined and the data file is stored in a corresponding reserved first storage space. Therefore, a case where downloading and storing of data file with the top priority level cannot be determined when a plurality of data files are downloaded simultaneously can be effectively avoided, and reliability in data downloading is effectively improved.

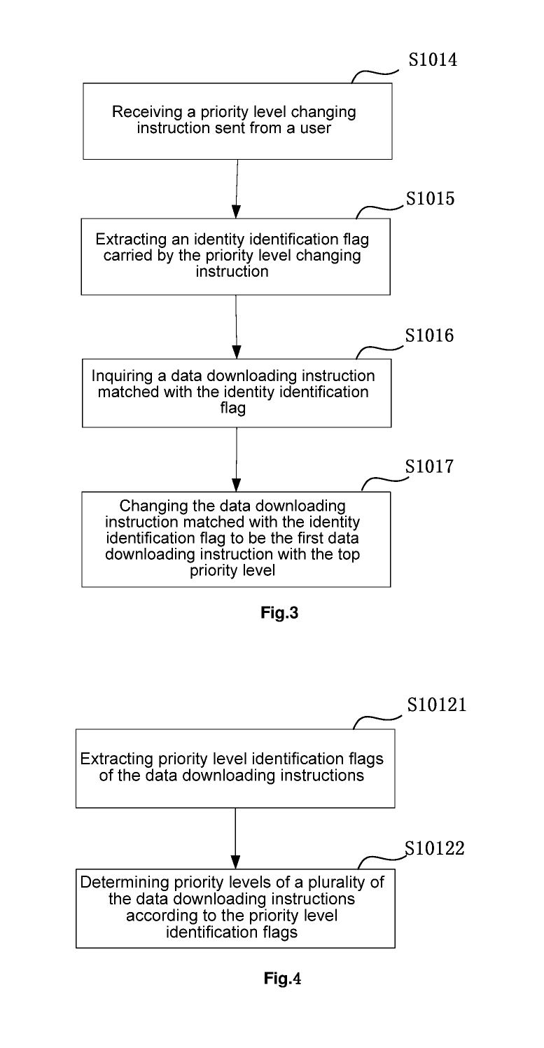

In the method for downloading data in the above embodiment, in the case that a plurality of data files are downloaded simultaneously, and a user does not designate which data is to be downloaded, priority levels are based on the time when data files start to be downloaded by clicking of a user. However, during an actual operation, a user is more likely to change priority levels of downloading data files. Therefore, the present disclosure further provides another embodiment of a method for downloading data, which may be referred to a schematic flowchart of a method for downloading data as shown in FIG. 3 for details. As shown in FIG. 3, the method may includes the following steps.

At step S1014, a priority level changing instruction sent from a user is received.

In an embodiment of the present disclosure, the priority level changing instruction is an instruction for changing a priority level of downloading a data file sent by a user, and the changed data file is determined to be the data file to be downloaded and stored by the user by changing the priority level of downloading the data file.

When the priority level changing instruction is received, at step S1015, an identity identification flag carried by the priority level changing instruction is extracted.

The priority level changing instruction may include an identity identification flag indicating a flag of a data downloading instruction, and the priority level changing instruction is used to determine which data downloading instruction for data file to be changed through the identity identification flag. In an embodiment of the present disclosure, the identity identification flag may be a character string, for example, the identity identification flag is a binary character string of four bits, such as 0010.

When the identity identification flag of the priority level changing instruction is extracted, at step S1016, a data downloading instruction matched with the identity identification flag is inquired.

A self identification flag, which is the same as the identity identification flag and may also be a character string, may be stored in advance in a data downloading instruction. The character string of the identity identification flag is obtained after the identity identification flag is received, and a data downloading instruction having a same flag as the identity identification flag is determined to be the data file with the priority level to be changed by inquiring all identification flags of data downloading instructions for data files. For example, there are data downloading instructions A, B and C of three data files, which have identification flags with character strings of 0010, 0011 and 0100 respectively, and if the received identity identification flag of the priority level changing instruction is 0011, the correspondingly inquired data file having a priority level to be changed is the data file corresponding to the data downloading instruction B.

When the data downloading instruction matched with the identity identification flag is inquired out, at step S1017, the data downloading instruction matched with the identity identification flag is changed to be the first data downloading instruction with the top priority level.

In an embodiment of the present disclosure, after a data downloading instruction required for changing a priority level of downloading is inquired out, the priority level of the data downloading instruction can be then modified, and the priority level of downloading a data file corresponding to the data downloading instruction is changed to be the top priority level, such that the data file can be stored in the generated first storage space after being completed download.

By application of the method, when a plurality of data files are downloaded simultaneously, a user can assign a storing priority level for a certain data file, such that a matched first storage space corresponding to the data file is generated, and thus the data file can be conveniently stored in the first storage space after being completed download, so as to prevent a case where the data file fails to be completed download because storage space in a terminal is occupied by other files during the downloading of the data file and thus a loss of data is rendered, from being occurred, thereby effectively improving reliability in data downloading.

Based on FIG. 3, in an embodiment of the present disclosure, as shown in FIG. 4, the step S1012 may includes the following steps.

When data downloading instructions of a plurality of data files are received, at step S10121, priority level identification flags of the data downloading instructions are extracted,

In the present embodiment, the data downloading instructions may be reserved with priority level identification flags in advance, and the priority level identification flag may be a character string. The priority level identification flag may include a time flag bit and a priority level flag bit, and the priority level of the priority level flag bit is higher than that of the time flag bit. When data downloading instructions of a plurality of data files are received, the priority level identification flag of each of the data downloading instructions corresponding to the data files is required to be extracted respectively.

When the priority level identification flags are extracted out, at step S10122, the priority levels of the plurality of data downloading instructions are determined according to the priority level identification flags.

In an embodiment of the present disclosure, generally, the priority levels of downloading data files may merely be based on the time flag bits of the priority level identification flags, for example, the earlier the time when it is started downloading, the higher the priority level is, and the characters of the priority level flag bits of the priority level identification flags are same with each other. If a priority level of a data downloading instruction is required to be changed, the top priority can be obtained by changing the character of the priority level flag bit to make it distinguish from the priority level identification flags of other data downloading instructions. For example, there are three data downloading instructions A, B and C, the data downloading starting times corresponding to which become later in sequence (in other words, the staring time corresponding to the data downloading instruction A is earlier than that corresponding to the data downloading instructions B and C), and the characters of the priority level flag bits corresponding to which are all 0, which indicates that the data downloading instruction A has the top priority level. When the priority level of the data downloading instruction C is required to be changed, the character of the priority level flag bit corresponding to the data downloading instruction B is changed to 1, in which case the data downloading instruction B has the top priority level, and the data downloading instructions A and C may still be arranged according to the priority levels of the time flag bits.

The above implementations are merely preferable implementations for explaining the present embodiment, and are not limited thereto in actually implementing process. Other same or similar implementations belong to the embodiment of the present disclosure, and detailed description thereof are omitted herein.

By application of the method, priority levels of data downloading instructions can be distinguished by the self priority levels of the time flag bits and priority level flag bits of the data downloading instructions, and can be determined according to the character strings within the time flag bits or the priority level flag bits, such that the sequence of priority levels of all data downloading instructions is finally determined, thus the data downloading instruction with the top priority level is further determined.

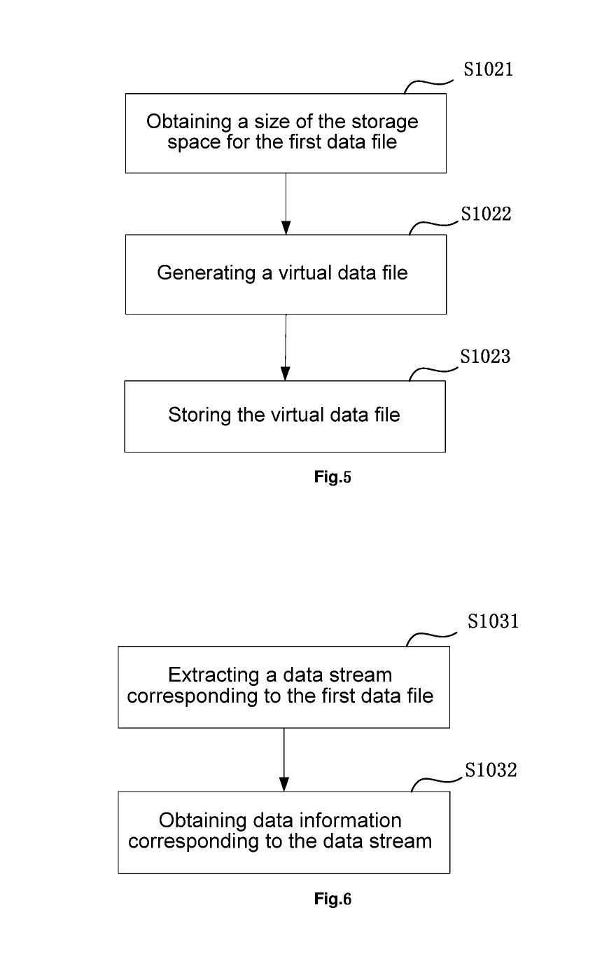

As shown in FIG. 5, which is a schematic flowchart of another method for downloading data according to an embodiment of the present disclosure, the method includes the following steps.

At step S1021, a size of the storage space for the first data file is obtained.

When the first data downloading instruction for the first data file to be download by a user is received, a first storage space corresponding to the first data file is required to be reserved for storing the first data file. Because a size of the generated first storage space should be at least the same as that of the first data file, the size of the storage space is required to be obtained through the first data file.

Furthermore, in an embodiment of the present disclosure, a data downloading instruction of a data file may include a file size of the corresponding data file, or a file size flag of the data file is carried by the data downloading instruction. The file size (generally, the file size of the data file is the size of a storage space for storing the data file) of the data file is stored, such that after the first data downloading instruction is received, the size of the storage space for the data file corresponding to the data downloading instruction can be directly obtained.

When the size of the storage space for the first data file is obtained, at step S1022, a virtual data file is generated.

In an embodiment of the present disclosure, to ensure a memory device in a terminal to have a storage space for storing the first data file, such that data information of the first data file can be completely downloaded and stored within the terminal, and to ensure a storage space capable of storing the first data file to exist, a virtual data file is required to be generated, and the virtual data file also occupies a storage space of the memory device of the terminal, but no substantive data information exists in the virtual data file. The first date file is required to cover the virtual data file after being completed download, so that the first date file is stored in the storage space previously occupied by the virtual data file.

Furthermore, the size of the storage space for the virtual data file is the same as that for the first data file, thereby facilitating the data information of the downloaded first data file can be completely stored in the storage space previously occupied by the virtual data file.

When the virtual data file is generated, at step S1023, the virtual data file is stored.

At step S1022, a virtual data file having a same size as the storage space for the first data file is generated, such that the virtual data file is stored in a memory device of a terminal, a storage space in the memory device is occupied by storing the virtual data file, and the occupied storage space is the first storage space for storing the data information corresponding to the first data file.

By application of the method, a storage space in a memory device of a terminal is occupied by generating a virtual data file, and the storage space is the one for correspondingly storing the first data file required to be downloaded, so as to ensure the first data file to be completed downloaded.

FIG. 6 is a flowchart illustrating a further method for downloading data according to an embodiment, and the method for downloading data includes the following steps.

At step S1031, a data stream corresponding to the first data file is extracted.

When a first storage space is generated, or after a virtual data file is generated and stored in a memory device of a terminal, a data stream of the first data file is extracted, wherein the data stream is a sequence of data which corresponds to the first data file to be downloaded, is stored in advance, has a order and is read once.

When the data stream corresponding to the first data file is extracted out, at step S1032, data information corresponding to the data stream is obtained.

In an embodiment of the present disclosure, the data stream corresponds to the data information of the first data file, and the corresponding data information is obtained in sequence through the data stream until all the data information corresponding to the first data file is completed download, such that the data information of the downloaded first data file is stored into the first storage space, and the virtual data file is completely covered by the first data file.

By the above implementation, after a first storage space having a same size as that of a first data file is generated, corresponding data information is obtained according to a data stream of the first data file, and all the data information is stored into the generated first storage space, such that a storage space in a terminal is prevented from being occupied by other data files, and a problem that data information fails to be downloaded due to a sudden insufficient storage space during downloading a data file, by which a loss of data is rendered, is effectively solved.

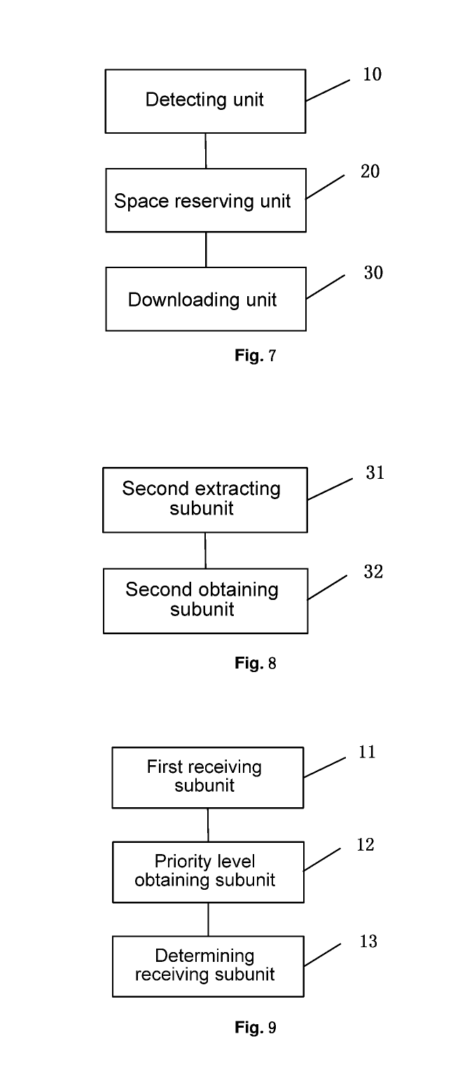

FIG. 7 is a block diagram illustrating a device for downloading data according to an embodiment. The device for downloading data may be applied to a terminal, such as a mobile phone, a tablet computer or the like. Referred to FIG. 7, the device includes a detecting unit 10, a space reserving unit 20 and a downloading unit 30.

The detecting unit 10 detects whether a first data downloading instruction for a first data file required to be downloaded sent by a user is received.

The space reserving unit 20 reserves a first storage space for the first data file when the first data downloading instruction is received.

The downloading unit 30 downloads the first data file to the first storage space.

A size of the first storage space reserved by the space reserving unit 20 is the same as a size of a storage space for the first data file, and the first storage space is used for storing data information corresponding to the first data file, and has a size smaller than or equal to that of the remained storage space of a terminal.

When the device is applied, if a user requires for downloading a data file, to prevent a storage space in a memory device of a terminal from being occupied by other data files during downloading data files, a first storage space for storing a first data file is reserved in the remained storage space of the terminal, such that the storage space for the first data file in the memory device of the terminal is occupied in advance, so as to ensure a successful downloading of the first data file required to be downloaded by the user, and prevent cases where the first data file fails to be downloaded due to insufficient storage space in the memory device of the terminal during the downloading thereof and the data information of the first data file is lost, from being occurred.

In an embodiment of the present disclosure, based on the embodiment shown in FIG. 7, as shown in FIG. 8, the downloading unit 30 of the device includes a second extracting subunit 31 and a second obtaining subunit 32, which are electrically connected to each other.

The second extracting subunit 31 extracts a data stream corresponding to the first data file.

The second obtaining subunit 32 obtains data information corresponding to the data stream corresponding to the first data file, and to store the data information to the first storage space.

By application of the device, a first data file required to be completed download by a user is stored in a generated first storage space, thereby improving integrity of data file downloading by way of occupying a storage space in a memory device of a terminal in advance.

In another embodiment of the present disclosure, as shown in FIG. 9, the above detecting unit 10 may include a first receiving subunit 11, a priority level obtaining subunit 12 and a determining receiving subunit 13.

The first receiving subunit 11 receives data downloading instructions for a plurality of data files sent by a use.

The priority level obtaining subunit 12 obtains priority levels of the data downloading instructions corresponding to the plurality of data files respectively.

The determining receiving subunit 13 determines a data file corresponding to a data downloading instruction with the top priority level to be the first data file required to be completed download, and determine that the first data downloading instruction is received.

In the device, priority levels of data downloading instructions may be determined based on the time when data files are started being downloaded, and the earlier the time when a data file is started being downloaded, the higher the priority level of the data downloading instruction corresponding to the data file is. Therefore, the data file having the earliest downloading starting time is determined to be the data file with the top priority level, and thus a first storage space matched with the data file is generated for storing the same.

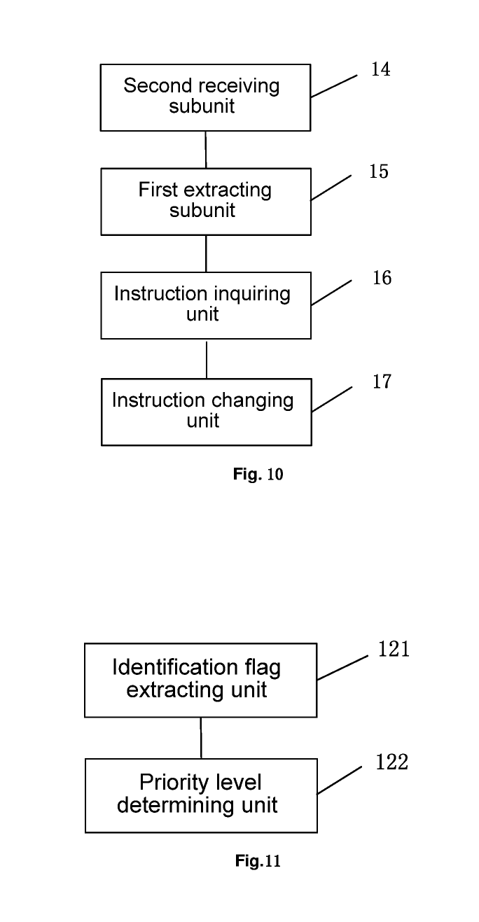

Based on the embodiment shown in FIG. 9, as shown in FIG. 10, the device may further include a second receiving subunit 14, a first extracting subunit 15, an instruction inquiring unit 16 and an instruction changing unit 17.

The second receiving subunit 14 receives a priority level changing instruction sent from a user, and the priority level changing instruction is used for changing priority levels of data downloading instructions corresponding to a plurality of data files.

The first extracting subunit 15 extracts an identity identification flag carried by the priority level changing instruction, and the identity identification flag may indicate a corresponding data downloading instruction.

The instruction inquiring unit 16 inquires a data downloading instruction matched with the identity identification flag.

The instruction changing unit 17 changes the data downloading instruction to be the first data downloading instruction with the top priority level.

The data downloading instruction is provided with a priority level identification flag which includes a time flag bit and a priority level flag bit, and the priority level represented by the priority level flag bit is higher than that represented by the time flag bit. The time flag bit may be represented as a time when the data file is started being downloaded, the earlier the time when it is started being downloaded, the higher the priority level is. The priority level flag bit may change a priority level by a simple assignment.

Based on the above FIG. 9, as shown in FIG. 11, the priority level obtaining subunit 12 includes an identification flag extracting unit 121 and a priority level determining unit 122.

The identification flag extracting unit 121 extracts priority level identification flags of data downloading instructions. The priority level identification flag includes a time flag bit and a priority level flag bit, and the priority level of the priority level flag bit is higher than that of the time flag bit.

The priority level determining unit 122 determines priority levels of a plurality of data downloading instructions according to the priority level identification flags.

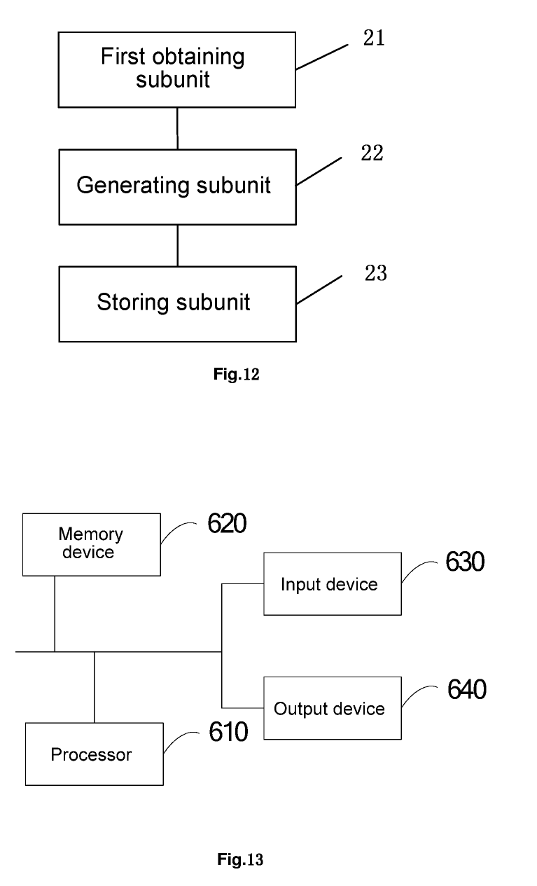

In another embodiment of the present disclosure, as shown in FIG. 12, the above space reserving unit 20 includes a first obtaining subunit 21, a generating subunit 22 and a storing subunit 23.

The first obtaining subunit 21 obtain a size of the storage space for the first data file, and the size of the storage space of the first data file is the same as that of the generated first storage space.

The generating subunit 22 generates a virtual data file, and a size of a storage space occupied by the virtual data file is the same as that of the storage space for the first data file.

The storing subunit 23 stores the virtual data, and the storage space corresponding to the virtual data is the first storage space.

In regard to the device mentioned in the above embodiment, the specific method of operating the respective unit has been described in the embodiments of the corresponding methods, and thus detailed descriptions thereof are omitted herein.

An embodiment of the present disclosure further provides a terminal, which includes part of or all of modules in the respective implementation of a device for downloading data provided by the embodiments in FIGS. 7-12 of the present disclosure.

The embodiments of the present disclosure further provide a non-volatile computer storage medium, the non-volatile computer storage medium is stored with computer executable instructions which are used to perform any of the methods for downloading data in the above embodiments.

FIG. 13 is a schematic structure diagram of an electronic device for performing a method for downloading data according to an embodiment. As shown in FIG. 4, the device includes one or more processors 610 and a memory device 620, and FIG. 13 illustrates one processor 610 as an example.

The device for performing a method of downloading data may further include an input device 630 and an output device 640.

The processor 610, memory device 620, input device 630 and output device 640 may be connected with each other through bus or other forms of connections. FIG. 4 illustrates bus connection as an example.

As a non-volatile computer readable storage medium, the memory device 620 may be configured to store non-volatile software program, non-volatile computer executable program and modules, such as program instructions/modules corresponding to the method for downloading data according to the embodiments of the disclosure (for example, the detecting unit 10, space reserving unit 20 and downloading unit, as illustrated in FIG. 7). By executing the non-volatile software program, instructions and modules stored in the memory device 620, the processor 610 may perform various functional applications of the server and data processing, that is, the method for downloading according to the above mentioned embodiments.

The memory device 620 may include a program storage area and a data storage area, the program storage area may be stored with the operating system and applications which are needed by at least one functions, and the data storage area may be stored with data which is created according to use of the device for downloading data. Further, the memory device 620 may include a high-speed random access memory, and may further include non-volatile memory, such as at least one of disk memory device, flash memory device or other types of non-volatile solid state memory device. In some embodiments, optionally, the memory device 620 may include memory device provided remotely from the processor 610, and such memory device may be connected with the device for downloading data through network connections. The examples of the network connections may include but not limited to internet, intranet, LAN (Local Area Network), mobile communication network or combinations thereof.

The input device 630 may receive inputted digital or character information, and generate key signal input related to the user settings and functional control of the device for downloading data. The output device 640 may include a display device such as a display screen.

The above one or more modules may be stored in the memory device 620, when these modules are executed by the one or more processor 610, the method for downloading data according to any one of the above mentioned embodiments may be performed.

The above product may perform the methods provided in the embodiments of the disclosure, include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:
(1) mobile communication device, characterized in having a function of mobile communication and mainly aimed at providing speech and data communication, wherein such terminal includes: smart phone (such as iPhone), multimedia phone, functional phone, low end phone and the like;
(2) ultra mobile personal computer device, which falls in a scope of personal computer, has functions of calculation and processing, and generally has characteristics of mobile internet access, wherein such terminal includes: PDA, MID and UMPC devices, such as iPad;
(3) portable entertainment device, which can display and play multimedia contents, and includes audio or video player (such as iPod), portable game console, E-book and smart toys and portable vehicle navigation device;
(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and
(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for downloading data, comprising at an electronic device:
detecting whether a first data downloading instruction for a first data file to be downloaded is received;
reserving a first storage space for the first data file when the first data downloading instruction is received; and
downloading the first data file to the first storage space.

2. The method for downloading data according to claim 1, wherein, the detecting whether the first data downloading instruction for the first data file to be downloaded is received comprises:
receiving data downloading instructions for a plurality of data files sent by a user;
obtaining priority levels of the data downloading instructions corresponding to the plurality of data files respectively; and
determining a data file corresponding to a data downloading instruction with the top priority level as the first data file, and determining that the first data downloading instruction is received.

3. The method for downloading data according to claim 2, further comprising:
receiving a priority level changing instruction sent from the user;
extracting an identity identification flag carried by the priority level changing instruction;
inquiring a data downloading instruction matched with the identity identification flag; and
changing the data downloading instruction matched with the identity identification flag to be the first data downloading instruction with the top priority level.

4. The method for downloading data according to claim 2, wherein, the obtaining the priority levels of the data downloading instructions corresponding to the plurality of data files respectively comprises:
extracting priority level identification flags of the data downloading instructions, wherein the priority level identification flag comprises a time flag bit and a priority level flag bit, and the priority level of the priority level flag bit is higher than that of the time flag bit; and
determining the priority levels of a plurality of the data downloading instructions according to the priority level identification flags.

5. The method for downloading data according to claim 1, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.

6. A non-volatile computer storage medium, which is stored with computer executable instructions that, when executed by one or more electronic devices, cause the electronic devices to:
detect whether a first data downloading instruction for a first data file to be downloaded is received;
reserve a first storage space for the first data file when the first data downloading instruction is received; and
download the first data file to the first storage space.

7. The non-volatile computer storage medium according to claim 6, wherein, the detecting whether the first data downloading instruction for the first data file to be downloaded is received comprises:
receiving data downloading instructions for a plurality of data files sent by a user;
obtaining priority levels of the data downloading instructions corresponding to the plurality of data files respectively; and
determining a data file corresponding to a data downloading instruction with the top priority level as the first data file, and determining that the first data downloading instruction is received.

8. The non-volatile computer storage medium according to claim 7, the electronic device is further caused to:
receive a priority level changing instruction sent from the user;
extract an identity identification flag carried by the priority level changing instruction;
inquire a data downloading instruction matched with the identity identification flag; and
change the data downloading instruction matched with the identity identification flag to be the first data downloading instruction with the top priority level.

9. The non-volatile computer storage medium according to claim 7, wherein, the obtaining the priority levels of the data downloading instructions corresponding to the plurality of data files respectively comprises:
extracting priority level identification flags of the data downloading instructions, wherein the priority level identification flag comprises a time flag bit and a priority level flag bit, and the priority level of the priority level flag bit is higher than that of the time flag bit; and
determining the priority levels of a plurality of the data downloading instructions according to the priority level identification flags.

10. The non-volatile computer storage medium according to claim 6, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.

11. A electronic device, comprising:
at least one processor; and
a memory communicably connected with the at least one processor, wherein the memory is stored with instructions executable by the at least one processor, and the instructions are executed by the at least one processor to cause the at least one processor to:
detect whether a first data downloading instruction for a first data file to be downloaded is received;
reserve a first storage space for the first data file when the first data downloading instruction is received; and
download the first data file to the first storage space.

12. The electronic device according to claim 11, wherein, the detecting whether the first data downloading instruction for the first data file to be downloaded is received comprises:
receiving data downloading instructions for a plurality of data files sent by a user;
obtaining priority levels of the data downloading instructions corresponding to the plurality of data files respectively; and
determining a data file corresponding to a data downloading instruction with the top priority level as the first data file, and determining that the first data downloading instruction is received.

13. The electronic device according to claim 12, wherein, the at least one processor is further caused to:
receiving a priority level changing instruction sent from the user;
extracting an identity identification flag carried by the priority level changing instruction;
inquiring a data downloading instruction matched with the identity identification flag; and
changing the data downloading instruction matched with the identity identification flag to be the first data downloading instruction with the top priority level.

14. The electronic device according to claim 12, wherein, the obtaining the priority levels of the data downloading instructions corresponding to the plurality of data files respectively comprises:
extracting priority level identification flags of the data downloading instructions, wherein the priority level identification flag comprises a time flag bit and a priority level flag bit, and the priority level of the priority level flag bit is higher than that of the time flag bit; and
determining the priority levels of a plurality of the data downloading instructions according to the priority level identification flags.

15. The electronic device according to claim 11, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.

16. The method for downloading data according to claim 2, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.

17. The method for downloading data according to claim 3, wherein, the obtaining the priority levels of the data downloading instructions corresponding to the plurality of data files respectively comprises:
extracting priority level identification flags of the data downloading instructions, wherein the priority level identification flag comprises a time flag bit and a priority level flag bit, and the priority level of the priority level flag bit is higher than that of the time flag bit; and
determining the priority levels of a plurality of the data downloading instructions according to the priority level identification flags.

18. The method for downloading data according to claim 17, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.

19. The non-volatile computer storage medium according to claim 8, wherein, the obtaining the priority levels of the data downloading instructions corresponding to the plurality of data files respectively comprises:
extracting priority level identification flags of the data downloading instructions, wherein the priority level identification flag comprises a time flag bit and a priority level flag bit, and the priority level of the priority level flag bit is higher than that of the time flag bit; and
determining the priority levels of a plurality of the data downloading instructions according to the priority level identification flags.

20. The non-volatile computer storage medium according to claim 19, wherein, the reserving the first storage space for the first data file comprises:
obtaining a size of a storage space for the first data file;
generating a virtual data file having a same size as that of the storage space for the first data file; and
storing the virtual data file, a storage space corresponding to which is the first storage space.
